(19) United States
(12) Patent Application Publication
(10) Pub. No.: US 2002/0180876 A1
(43) Pub. Date: Dec. 5, 2002

(54) Intelligent motion blur minimization

(76) Inventor: Robert E. Sobol, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/872,076

(22) Filed: Jun. 1, 2001

(51) Int. Cl. H04N 3/14

(52) U.S. Cl. 348/296

(57) ABSTRACT

A method and device for minimizing blur in digital photography. The method increases the shutter speed of the camera, when possible, if the camera detects motion induced blur in the scene.

### FIELD OF THE INVENTION

The present invention relates generally to digital cameras and more specifically to a method for the reduction of blurred images.

### BACKGROUND OF THE INVENTION

Many consumer photographs are spoiled by motion blur. Sometimes blur is caused by movement of the camera and sometimes the blur is caused by subject motion. Exposing with faster shutter speeds and a corresponding larger lens aperture could have improved many of these photos. Unfortunately many of the automatic cameras today don't permit this trade off between shutter speed and aperture. Even when the cameras are taken out of their automatic mode, many consumers don't have the knowledge to set the speed and aperture appropriately.

What is needed is a method that increases the shutter speed automatically, if possible, when motion induced blur is detected in the image.

### SUMMARY OF THE INVENTION

A method and device for minimizing blur in digital photography. The method increases the shutter speed of the camera, when possible, if the camera detects blur or motion in the scene.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a flow chart in accordance with the present invention.

### DETAILED DESCRIPTION OF THE PREFERRED EMBODIMENT

A method and device for minimizing blur in digital photography can increase the number of usable images captured by the device.

During the time a user is composing a scene, a digital camera constantly makes new exposures on the photo sensor (typically a CCD). These exposures can be referred to as frames. Typically these frames are a sub-sample of the full resolution of the photo sensor. However, full resolution frames can be created. Some frames are at full resolution but do not use the full size of the photo sensor; they use a sub-region of the photo sensor. Frames are used for a number of calculations to help the digital camera determine the proper settings for the capture of the scene. Some examples of the settings are focus, shutter speed, aperture stop, and ISO setting. The shutter speed, aperture stop, and ISO settings are typically tied together to give the proper exposure for the photo sensor.

Cameras today, when in their automatic mode, may have a number of different selectable settings that optimize different parameters using the three exposure adjustments. For example cameras may have a general mode, a portrait mode, a landscape mode and a sports mode. Each of these settings may adjust the three exposure controls to optimize a different parameter. For example the portrait mode may try to maximize the f-number, the sports mode may preferentially set a faster shutter speed, the landscape mode may try to maximize the depth of field, and the general mode may use a balance between the shutter speed, the aperture stop, and the ISO setting.

When a camera is set in the sports mode the shutter speed is typically set at the fastest setting allowable, given the available light, the aperture stops available, and an acceptable signal to noise ratio. This trade off between the three exposure controls is currently done without measuring the blur or motion in the image to be captured. This may cause a fast shutter speed to be set even when there is no blur or motion in the image to be captured. A fast shutter speed may not be the optimum setting for an image with little or no motion or blur. For example in a low light setting with little or no motion, the best image may be created using the largest f-stop, a moderate ISO setting and a longer shutter speed. By increasing the shutter speed only when motion or blur is detected other parameters can be optimized without the risk of the image being ruined by too slow a shutter speed. This method can be used in all the automatic exposure modes.

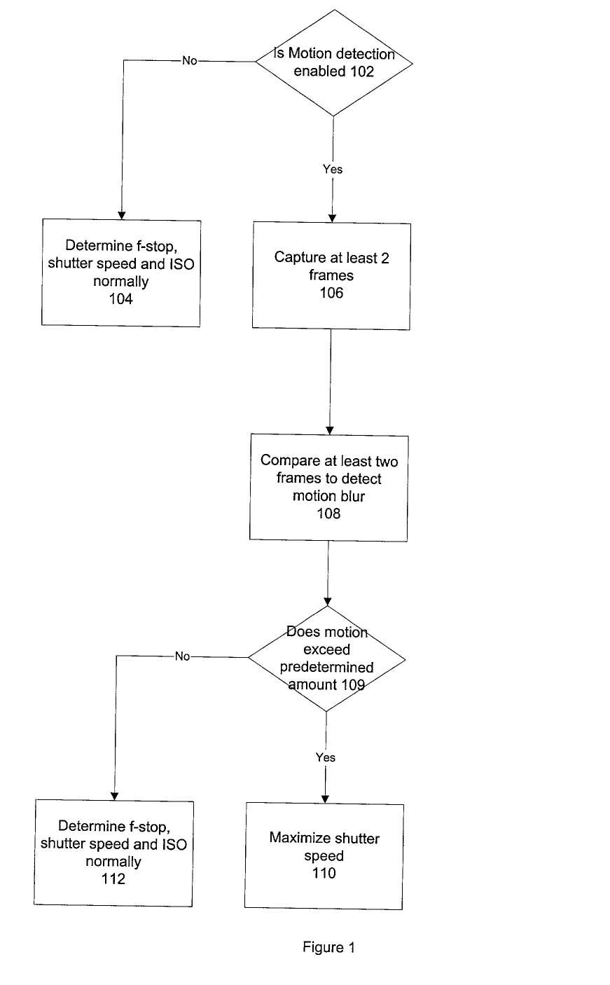

In one embodiment of the current invention the shutter speed is maximized only when an image has motion induced blur (see FIG. 1). This feature may be disabled for images where motion blur is desirable, for example an image of a waterfall. The camera first checks if the motion detection is enabled (102). When motion detection is not enabled, shutter speed, f-stop, and ISO number are determined normally (104). When motion detection is enabled, at least two frames are captured (106). The two frames are compared to determine motion or blur in the scene (108). When the motion or blur in the scene exceeds a predetermined amount, the shutter speed is maximized in the trade off between the available light, f-stops, and ISO setting (110).

There are two main causes of motion blur in images, camera movement and subject movement. These two types of movement cause different effects in the image. Camera movement can cause motion blur in a stationary scene. All areas in the scene will be approximately equally blurred. Subject movement, for example a person running, causes the moving subject to be blurred, while the rest of the scene will typically be non-blurred. These two types of motion may be present in one image. These two types of motion blur are well known in the arts and there are many different ways to detect these effects in an image or set of images.

One way to detect movement between two images is described in U.S. Pat. No. 6,195,475 (Beausoleil) “Navigation system for handheld scanner” which is hereby incorporated by reference. In Beausoleil, the correlation between two images is measured using a general two-dimensional Taylor series expansion. The correlation between the two images corresponds to the relative displacement between the two images. By calculating the correlation between two successive frames from a digital camera using the method in Beausoleil, the relative motion of the camera can be determined. When this motion exceeds a predetermined amount, the shutter speed of the camera can be maximized. In another embodiment the shutter speed may be set as a function of the amount of movement between the two frames. For small camera movements the speed may not need to be set at the fastest shutter speed. For larger camera movements the shutter speed may be set to its fastest setting.

Another way to detect movement or blur between two images is by computing the absolute value of the difference between corresponding pixels from the two frames. This method is commonly called the subtraction method (see “Fundamentals of Digital Image Processing” by Anil K. Jain, published by Prentice Hall. ISBN 0-13-336165-9 page 400). By using a summery statistic such as the average of the differences, an estimate of the motion in the scene can be determined. A large average difference indicates motion. When the average difference between two frames exceeds a predetermined amount, the shutter speed of the camera can be maximized.

Another way to detect movement or blur between two images is by template matching (see “The Image Processing handbook Third Edition” by John C. Russ, CRC Press, ISDN 0-8493-2532-3. Pages 365-367). By using one of the frames as a target pattern and finding the correlation between the target pattern and the second frame using template matching, an estimate of the motion in the scene can be determined. When the estimated motion between the two frames exceeds a predetermined amount, the shutter speed of the camera can be maximized.

Camera motion blur can be caused when the user presses the camera shutter. Often when a photographer is excited or is trying to capture a scene quickly, they may depress the shutter button with great force, thereby introducing camera motion that blurs the captured image. Because of this common cause, the frames used to detect motion blur may be taken immediately before recording the final image. The camera can be continually taking frames, and use only the last frames taken before the shutter is triggered. Or, the camera can quickly take two frames just after the shutter is triggered and prior to capturing the final image.

More than two frames can be used to calculate the motion blur in the scene.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of adjusting the shutter speed of a digital camera, comprising:
measuring the motion blur in an image;
maximizing the shutter speed when the motion blur exceeds a predetermined amount.

2. The method of claim 1, further comprising:
capturing at least two frames;
comparing at least two frames to determine the amount of motion blur in the image.

3. The method of claim 1 where the shutter speed in not increased when an aperture is already open at its maximum size.

4. The method of claim 2 where the two frames are compared using the absolute value of the difference between the corresponding pixels from the two frames.

5. The method of claim 2 where the two frames are compared using a general two-dimensional Taylor series expansion.

6. The method of claim 2 where two frames are compared using template matching.

7. The method of claim 2 where the two frames are captured immediately before the finial image is captured.

8. A digital camera, comprising:
a photo sensor;
a lens that forms an image on the photo sensor;
a shutter with an adjustable speed that controls the length of time the photo sensor sees the image;
a processor configured to measure the amount of motion blur in the image, the processor configured to maximize the speed of the shutter when the motion blur exceeds a predetermined amount.

9. The device of claim 7, further comprising:
a processor configured to capture at least two frames from the photo sensor and compare at least two frames to determine the amount of motion blur between the two frames.

10. The device of claim 7, further comprising:
a processor configured not to increase the shutter speed when an aperture is already at its maximum opening.

11. A digital camera, comprising:
a photo sensor;
a lens that forms an image on the photo sensor;
a shutter with an adjustable speed that controls the length of time the photo sensor sees the image;
a means for detecting blur in a scene;
a means for adjusting the shutter speed in response to the blur detected.

12. A method of adjusting the shutter speed of a digital camera, comprising:
measuring the motion blur in an image;
setting the shutter speed as a function of the amount of motion blur.

13. The method of claim 1, further comprising:
capturing at least two frames;
comparing at least two frames to determine the amount of motion blur in the image.

14. The method of claim 12 where the shutter speed in not increased when an aperture is already open at its maximum size.

15. The method of claim 13 where the two frames are compared using the absolute value of the difference between the corresponding pixels from the two frames.

16. The method of claim 13 where the two frames are compared using a general two-dimensional Taylor series expansion.

17. The method of claim 13 where two frames are compared using template matching.

18. The method of claim 13 where the two frames are captured immediately before the final image is captured.

19. A digital camera, comprising:
a photo sensor;
a lens that forms an image on the photo sensor;
a shutter with an adjustable speed that controls the length of time the photo sensor sees the image;
a processor configured to measure the amount of motion blur in the image, the processor configured to set the speed of the shutter as a function of the amount of motion blur.

20. The device of claim 7, further comprising:
a processor configured to capture at least two frames from the photo sensor and compare at least two frames to determine the amount of motion blur between the two frames.
